(19) United States
(12) Patent Application Publication
(10) Pub. No.: US 2017/0369241 A1
(43) Pub. Date: Dec. 28, 2017

(54) PEDAL MECHANISM AND BIN COMPRISING THE SAME

(71) Applicant: CURVER LUXEMBOURG SARL, Neidercorn (LU)

(72) Inventor: Nikolai DUVIGNEAU, Zichron Yaacov (IL)

(73) Assignee: CURVER LUXEMBOURG SARL, Neidercorn (LU)

(21) Appl. No.: 15/542,543

(22) PCT Filed: Jan. 10, 2016
(86) PCT No.: PCT/IL2016/050027

§ 371 Date: Jul. 10, 2017

Related U.S. Application Data
(60) Provisional application No. 62/102,008, filed on Jan. 10, 2015.

(51) Int. Cl. B65F 1/16; B65F 1/04; B65F 1/02

(52) U.S. Cl. CPC B65F 1/163; B65F 1/1646; B65F 1/02; B65F 1/04

(57) ABSTRACT

Provided is a pedal mechanism, a multilever rocker and an associated pedal type bin assembly. The bin includes a top and a bottom, a lid pivotably attached at a top portion of a rear wall of the bin, and a pedal mechanism disposed at a bottom portion of the bin. The bin further includes a lid manipulating member extending between the lid and the pedal mechanism. The pedal mechanism includes a pedal provided at a front portion at the bottom portion of the bin, a force transmitting system and a connecting element couplable to the lid manipulating member at a rear portion of the bin bottom portion. The pedal mechanism forms part of the bin's base portion at the bottom thereof with the bin and the pedal mechanism.

### TECHNOLOGICAL FIELD

The disclosed subject matter relates to a pedal mechanism and more particularly to a pedal operated bin system comprising the same.

### BACKGROUND ART

References considered to be relevant as background to the presently disclosed subject matter are listed below:
CN202624889
CN2550314
GB1522783
US2012152958
WO02083525
U.S. Pat. No. 5,249,693
US2005133506
WO2008130239
U.S. Pat. No. 7,806,285
U.S. Pat. No. 8,136,688
US2010147865

Acknowledgement of the above references herein is not to be inferred as meaning that these are in any way relevant to the patentability of the presently disclosed subject matter.

### BACKGROUND

Various types of pedal mechanisms and bins comprising the same are known in the art. Some of these are disclosed in the referenced prior art references acknowledged hereinabove. For example, U.S. Pat. No. 8,136,688 is directed to a trash can assembly having an [symbol] ter shell and a lid pivotally coupled to the shell for movement between an open [symbol] sition and a closed position. A foot pedal is operatively coupled to the lid such that [symbol] ssing down on the pedal caused the lid to open. A fluid damper is mounted to [symbol] rnpen the downward movement of a lid. The damper engages a support surface [symbol] eratively coupled to the lid such that the support surface moves in conjunction with [symbol] wement of the lid as the lid moves between the open position and the closed position, [symbol] d yet the fluid damper is unsecured to the support surface.

Another example is disclosed in U.S. Pat. No. 7,806,285 directed to a trash can assembly [symbol] ving a lid pivotably coupled to an upper end of an outer shell, and a pivoting pedal [symbol] r that is coupled to the lid via a link rod. The closing motion of the lid is dampened by [symbol] anter-balancing the closing force of the lid, which can be accomplished by generating [symbol] counter-balance force against the pedal bar that is equal to or slightly less than the) [symbol] sing force of the lid. The counter-balance force can be made to vary during the) [symbol] sing motion of the lid. In addition, the entire link rod can be positioned inside the [symbol] erior of the outer shell, and the pivot axis of the lid about the outer shell can also be [symbol] sitioned inside the interior of the outer shell.

### GENERAL DESCRIPTION

The disclosed subject matter is directed to a pedal mechanism. The pedal [symbol] chanism in accordance with the disclosed subject matter can form part of any [symbol] ntainer system comprising, for example, a pivotable lid. The pedal mechanism, in [symbol] cordance with the disclosed subject matter, facilitates opening of the lid by [symbol] nsmission of force applied on a pedal and transmitted to the lid opening mechanism [symbol] rough the pedal mechanism of the present subject matter. The pedal mechanism [symbol] ilitates pulling of the lid to its open position rather than pushing and lifting of the [symbol] me by a lifting mechanism.

In accordance with one aspect of the disclosed subject matter there is disclosed a [symbol] dal type bin assembly comprising a bin having a top and a bottom, a lid pivotably [symbol] ached at a top portion of a rear wall of the bin, and a pedal mechanism disposed at a [symbol] ttom portion of the bin, wherein the bin further comprises a lid manipulating member [symbol] tending between the lid and the pedal mechanism and wherein the pedal mechanism comprises a pedal provided at a front portion at the bottom portion of the bin, a force [symbol] nsmitting system and a connecting element couplable to the lid manipulating member [symbol] a rear portion of the bin bottom portion, configured for manipulating the lid between [symbol] open and a closed position upon respective operation of the pedal mechanism.

In accordance with an example, the pedal mechanism of the pedal type bin [symbol] mprises a base lever actuatable by the pedal, the base lever having a first member and [symbol] econd member flexibly connected through at least one hinge, wherein each one of the [symbol] int member and the second member comprises at least one laterally extending torsion [symbol] rs configured to axially support the base lever and connecting it to laterally extending [symbol] rallel supporting surfaces and wherein the torsion bars allow swinging of the base [symbol] er relative to the supporting surface and wherein the force applied at a frond edge of [symbol] front member is transmitted to the rear edge of the rear member.

In accordance with an example of this aspect, the bin and the pedal mechanism [symbol] a unitary and integral structure. In accordance with another example, the pedal [symbol] mechanism and the bin are articulated to each other. In accordance with yet an example, [symbol] pedal and the force transmission mechanism are integrally formed. In accordance [symbol] th another example, the pedal is detachably attachable to the pedal mechanism.

In accordance with an example, the pedal type bin assembly further comprises a [symbol] i liner or an inner bin. In accordance with yet an example, the liner is configured to at [symbol] ist partially line and cover an inside surface of the bin. In accordance with yet an [symbol] ample, the liner is configured to cover the bottom portion of the inside surface of the [symbol] a. The liner can be an integral part of the bin or a removable component thereof.

In accordance with another aspect of the disclosed subject matter there is) [symbol] vided a pedal mechanism. The pedal mechanism in accordance with this aspect [symbol] mprises a base lever actuated by a pedal (which can form an integral part of the pedal [symbol] chanism or be detachably attachable thereto). The force transmission mechanism [symbol] mprises a base lever having a first member disposed at the front and a second lever [symbol] tuber disposed at the rear flexibly connected through at least one hinge, e.g. integral [symbol] age, and wherein each of the front member and the second member comprise at least [symbol] e laterally extending torsion bar configured to axially support the base lever allowing [symbol] nnection to lateral supporting surfaces and allowing swinging of the base lever [symbol] ative to the supporting surface, and wherein the force applied at a frond portion of the [symbol] nat member is transmitted to the rear portion of the rear member. The first member and the second member can be an integral unit interconnected by an integral hinge. In [symbol] ordance with another example, the first member and the second member can be) [symbol] arate elements configured for articulation one with the other through at least one [symbol] iging member.

The pedal mechanism and/or the pedal bin can be formed from any suitable [symbol] aerial, as plastic, metal, rubber, silicone etc.

In accordance with yet an aspect there is provided a multi-lever rocker actuating [symbol] chanism comprising a first lever member pivotable about a first axis and a second [symbol] Ter member pivotable about a second axis, a front end of the first lever comprising an [symbol] eating pedal and a rear end of the first lever is pivotally articulated to a front end of [symbol] rear lever; a rear end of the rear lever is configured for articulating to a bottom end [symbol] the lid manipulating member having a top end thereof pivotally articulated to a pivot [symbol] the rear end of the lid, wherein downward displacement of the actuating pedal entails [symbol] oting of the first lever in a first direction and corresponding pivotal displacement of [symbol] second lever in an opposite direction, such that the rear end of the second lever [symbol] places downwards, resulting in corresponding downwards displacement of the lid [symbol] anipulating member, whereby downwards displacement of the lid manipulating [symbol] ember in turn entails downwards displacement of the rear lid portion, resulting in [symbol] votal displacement of the lid into its open position.

The following parameters can alter the force and displacement factors of the lid [symbol] tuating mechanism:

The length of the levers;

The positioning of the axes of the levers;

The pre-angular positioning of the levers;

According to a particular configuration of the disclosure, the first axis and the [symbol] cond axis are substantially parallel to one another;

In accordance with one example, the at least first lever and the at least second [symbol] ver are connected directly to each other. In accordance with another example the at [symbol] ast first lever and the at least second lever are connected through an interconnecting [symbol] k. In the case of the latter, the interconnecting link extends between the top rear of [symbol] e first lever member and bottom front of the second lever member.

In accordance with one example the axis extending through the first lever and [symbol] second lever are constituted by torsion bars. In accordance with another example the [symbol] are normal axis bars, with no torsioning properties.

Downwards displacement of the lid manipulating member is substantial axial [symbol] placement, taking place along its longitudinal axis;

The above is the sequence of operation of a normally closed lid, wherein [symbol] lowing the release of force from the actuating pedal, the lid will spontaneously [symbol] place into a normally closed position, under its self weight, upon seizing downward [symbol] ce on the actuating pedal

It is appreciated that the number of levers in the sequence of the multi-lever [symbol] angement can be any pair number.

Biasing of the system into dampened closing of the lid can be facilitated by [symbol] lizing a torsion mechanism articulated to one or more of the pivoting locations of the [symbol] ilti-lever train.

### BRIEF DESCRIPTION OF THE DRAWINGS

In order to better understand the subject matter that is disclosed herein and to [symbol] emplify how it may be carried out in practice, embodiments will now be described, [symbol] way of non-limiting examples only, with reference to the accompanying drawings, in [symbol] rich:

FIGS. 1A and 1B are a perspective front view and side view of the pedal bin in [symbol] accordance with an example of the disclosed subject matter in a closed position, [symbol] spectively;

FIG. 2 is a perspective view of the lid and a lid manipulating mechanism used in [symbol] e bin of FIG. 1B;

FIG. 3 is a top view of the bin of FIG. 1, devoid of the lid;

FIG. 4 is a longitudinal cross section of the bin along line C-C in FIG. 1A, the lid [symbol] d the lid manipulating mechanism at the closed position;

FIGS. 5A to 5C illustrate the side cross sections of torsion bars in accordance [symbol] ith the disclosed subject matter;

FIGS. 6A and 6B are a perspective front view and a perspective top view of the bin in FIGS. 1A and 1B in an open position, respectively;

FIG. 7 is the same as FIG. 4, however with the lid and the lid manipulating mechanism at the open position;

FIGS. 8A and 8B illustrate a bin in a top and a perspective side cross section, respectively, in accordance with an example of the disclosed subject matter, fitted with a bin liner;

FIG. 9 illustrates a front view of the liner in accordance with an example of the disclosed subject matter;

FIGS. 10A and 10B illustrate a pedal mechanism in a perspective view and a top view in accordance with the disclosed subject matter.

### DETAILED DESCRIPTION OF EMBODIMENTS

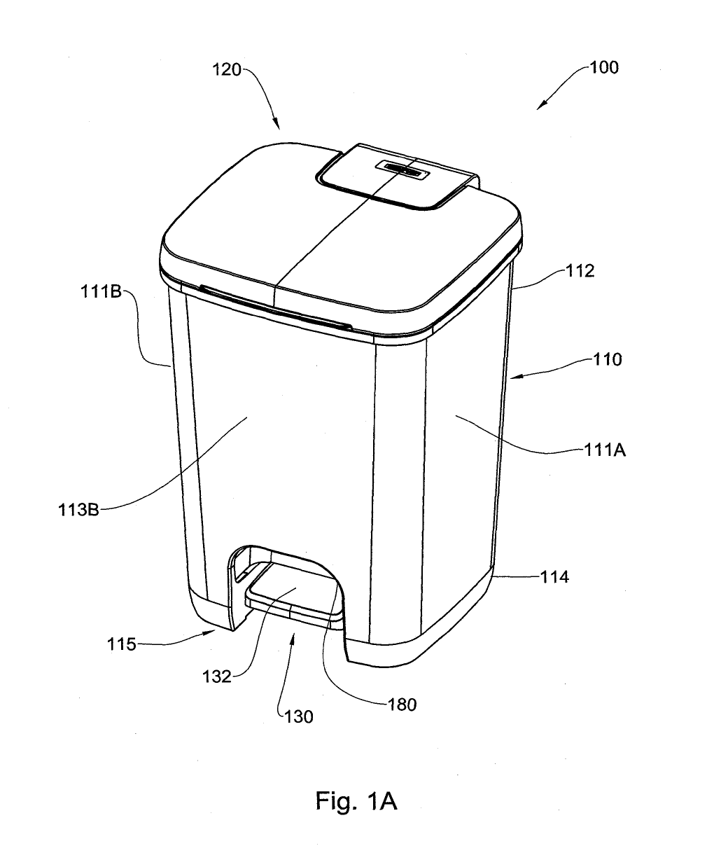

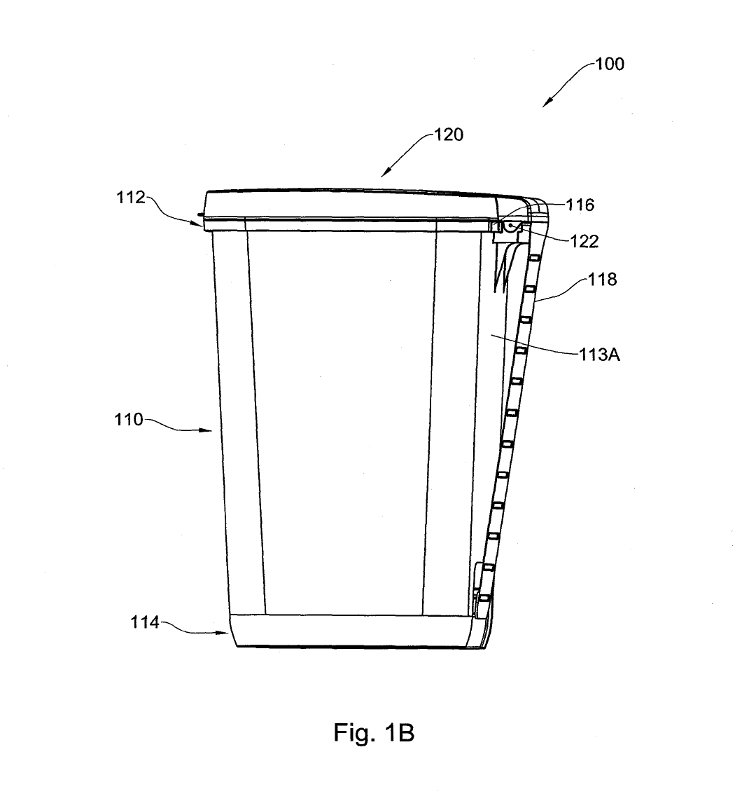

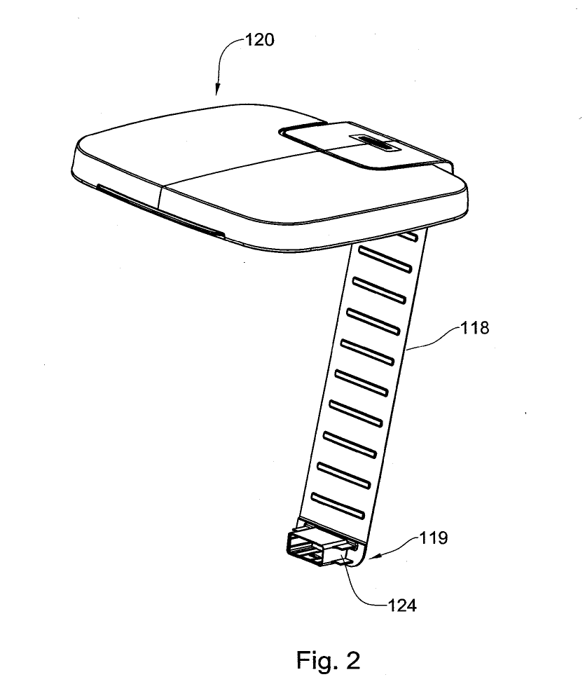

FIGS. 1A and 1B illustrate a pedal type bin assembly generally designated 100. The assembly 100 comprising a bin 110 having a top 112 and a bottom 114, a pivotably attached lid 120 at a rear end 116 of the bin top 112 and a pedal mechanism generally designated 130 and best seen in FIG. 3 extending at the bottom 114 of the bin 110. The bin 110 further comprises a lid manipulating member 118 extending between the lid 120 and the pedal mechanism 130. The bin comprises side walls 111A and 111B, rear wall 113A bearing the lid 120 at its top and a front wall 113B provided with an opening 180 for allowing access for operating the pedal mechanism 130, e.g. by users' foot. The pedal mechanism 130 comprises a pedal 132 provided at a front side 115 at the bin bottom 114, a force transmitting system 150 (seen in FIG. 3) and a connecting element 155 couplable to the lid manipulating member 118 at the rear side 117 of the bin bottom 114, configured for manipulating the lid 120 between an open and a closed position upon respective operation of the pedal mechanism 130.

In accordance with this example, the bin 110 and the pedal mechanism 130 are integrally formed together. Optionally, the bin and the pedal mechanism can be separate members. The bin 110 with the pedal mechanism 130 are injection molded from a plastic material. It will be appreciated that other materials and methods of manufacturing are envisioned. Material for the bin can be e.g. metal, foil covered plastic etc. the pedal mechanism can also be formed from other materials, e.g. metal, wood, rubber etc. The lid 120 and the lid manipulating member 118, which are in form of a strap in the current example, are in turn formed as an integral unit in an injection [symbol] ding process. The material used or the formation of the lid manipulating member [symbol] 8 is sufficiently flexible to facilitate deformation thereof upon manipulation without [symbol] tting unnecessary stress on the strap which might result in cracking or snapping of the [symbol] ne. It will be appreciated that the lid and the lid manipulating member can be) [symbol] crate and made from different materials and the lid manipulating member can have [symbol] rious shapes as desired from a single slim rod to a broader strap or a more complex [symbol] ucture configured to connect the lid to the pedal mechanism. For example, the lid [symbol] nipulating member can be a metal rod or a metal strap.

The lid 120 is configured for articulation to the bin 110 through a hinge element [symbol] 2 which provides for the pivotal movement of the lid 120 with respect to the bin 110. [symbol] will be appreciated that the lid can be articulated to the lid manipulation member e.g. [symbol] sough an integral hinge. The free end 119 of the lid manipulation member 118 is) [symbol] vided with a socket 124 configured for detachable attachment to the connecting [symbol] inent 155, forming a male to female fixed connection. Other types of connections are [symbol] visioned, e.g. a snap type connection, adhesion, welding, hinged connection, etc. or [symbol] egration of the parts in one single unit.

Referring now to FIG. 3, the bin 110 is illustrated viewed from the top. The bin [symbol] 0 comprises at its bottom 114 the pedal mechanism 130 which in this example forms [symbol] integral part of the bin. The pedal mechanism 130 comprises a base lever 135 [symbol] tuated by a pedal 132 (which in this example forms an integral part of the pedal [symbol] echanism however it will be appreciated that this element can be detachably [symbol] achable or a separate member fixedly fitted thereto). The base lever 135 has a first, [symbol] nt member 136 and a second, rear member 138 flexibly connected through a hinge [symbol] 10, in this example an integral hinge. It will be appreciated that the first member and [symbol] e second member can be separate members interconnected through at least one hinge [symbol] le front member 136 has a fore end connecting to the pedal 132 and a rear end 137 [symbol] nfigured for connecting to the second member 138, a top surface 139 and a bottom [symbol] rface (not shown); the second member 138 has a fore end 139 configured for [symbol] nnecting to the first member 136 and a rear end fitted with a connecting element 155 [symbol] hich is an outward protrusion configured to fixedly engage the socket 124 of the [symbol] anipulating strap 118. The second member 138 further has a top surface 141 and a [symbol] ttom surface (not shown). The integral hinge 140 extends diagonally from the bottom surface of the fore end of the second member 138 and to the top of the rear edge of the [symbol] st lever member 136. In the present example, the connection between the top rear end [symbol] the first member 136 to the hinge 140 at the bottom fore end of the second lever [symbol] amber 138 extends through another integral hinge 142. In the illustrated example, the [symbol] st member and the second member are diagonally connected by an intermediate [symbol] erconnecting link in the form of a hinging strap 145, connecting the members through [symbol] hinges 140 and 142. Thickness of the hinging strap 145 is in this case smaller than [symbol] it of the lever members and larger than that of the hinges constituted by thinned out [symbol] rtions (e.g. integral hinges). However it will be appreciated that the connection can be [symbol] ide using alternative connecting members, e. g., one or more connecting strings etc. [symbol] directly to each other by various means, e.g. an integral hinge.

The base lever 135 is connected to the base bottom through laterally extending [symbol] sion bars 162A, 162B, 164A and 164B configured to axially support the base lever [symbol] 5 allowing connection to lateral supporting surfaces 160A and 160B extending from [symbol] d in parallel to the side walls of the bin. This allows controlled swinging of the base [symbol] er 135 (and if present of the pedal member 132) relative to the supporting surfaces [symbol] ien the force applied at a frond edge of the front member 136 is transmitted to the rear [symbol] ge of the rear member 138, as will be discussed hererinafter. The torsion bars [symbol] nnected to the supporting surfaces have thus a restrained warping at the root which [symbol] ows the base lever members 136 and 138 to swing back to their initial position when [symbol] force is released. It will be appreciated that a regular axis can be used to manipulate [symbol] levers.

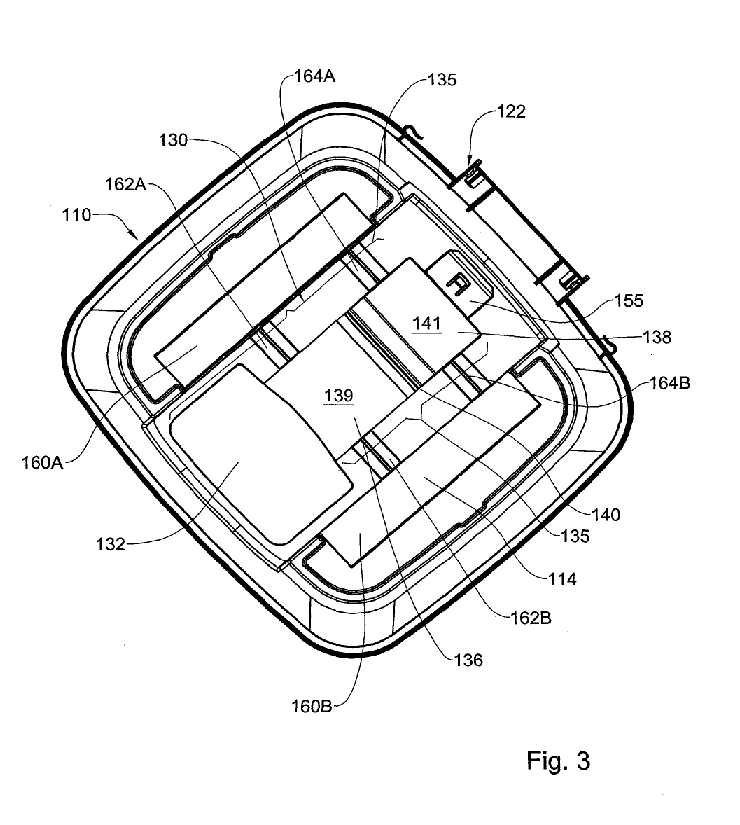

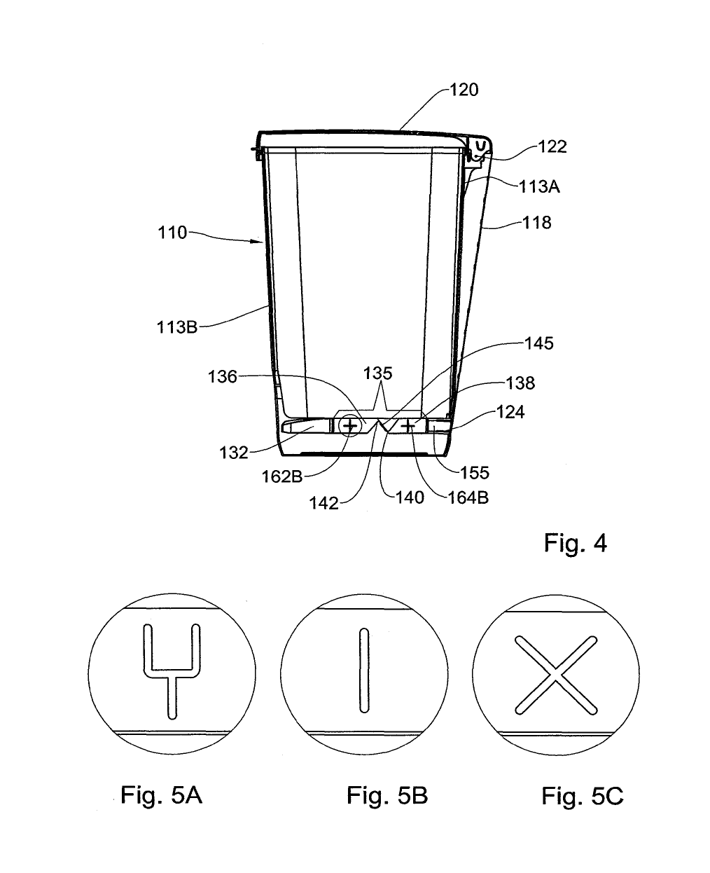

As seen in FIG. 4, the torsion bars 162 have a shape of cross (+) in their cross [symbol] ction. However, it will be appreciated that bars having another cross section are [symbol] visioned, as exemplified in FIGS. 5A to 5C, showing a y-shaped, a straight line or an [symbol] shaped bars, respectively, as well as I, U or other shapes of bars can be used as [symbol] rsion axis bars.

The operation of the lid 120 and the pedal mechanism 130 will be discussed [symbol] ith reference to drawings in FIGS. 3, 6B, and 7. To open the lid 120 of the bin [symbol] sembly 100, the pedal 132 is pressed down in the direction of arrow D, this exertion [symbol] force is in turn transmitted by the pedal mechanism 135 to downward pulling of the [symbol] 1 manipulating strip 118 towards the bottom 114 of the bin 110 in the direction of [symbol] row d. substantially parallel to the direction D, which in turn causes the lid 120 to pivot (arrow p) in a rearward direction, thus opening the lid 120 and allowing access to [symbol] inner space S of the bin 110. The pedal mechanism 130 allows this transmission of [symbol] ce via the base lever 135 and facilitated by the torsion bars 162AB and 164AB [symbol] ping the base lever attached to the bin bottom.

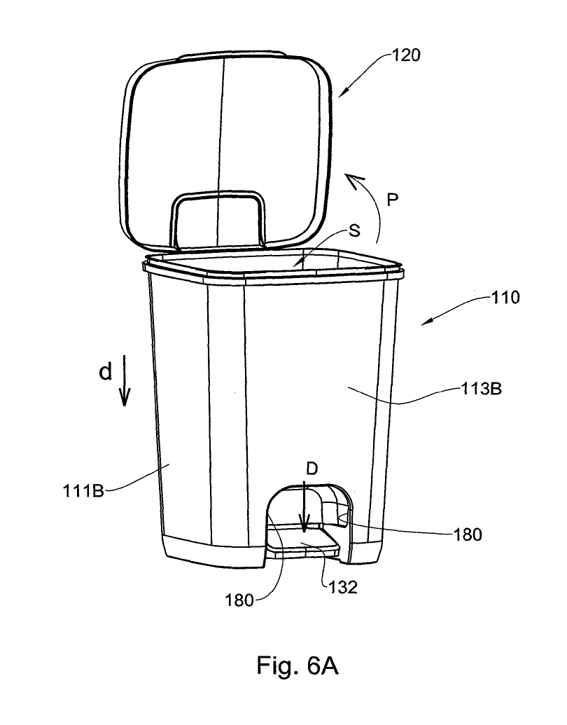

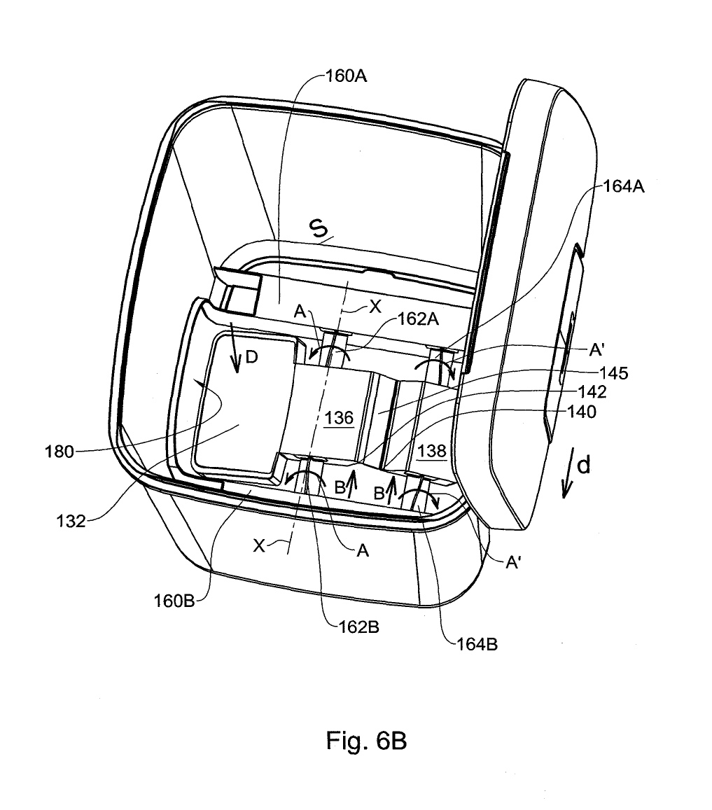

By pressing the pedal member 132, the rear end of the front lever member 136 is [symbol] shed up in the direction of arrow B with the torsion bars 162A and 162B supporting [symbol] same and extending along the same axis X which are warped or twisted in the [symbol] unter clockwise direction of arrow A, i.e. towards the pressed pedal. This action, in [symbol] n, pulls the front edge of the rear lever member 138 upward (in the direction B) [symbol] ough the strip 145 which is pulled up by the rear end of the first member. Facilitated [symbol] the hinge 140, the structure is rendered flexible and cracking of the plastic is [symbol] oided. The torsion bars 164A and 164B twist in the clockwise direction, i.e. opposite [symbol] ection from the bars 162A and 162B, causing this upward movement of the front end [symbol] the rear lever member 138 to translate into the downward movement of the rear end [symbol] the rear lever member, i.e. the connecting element 155, tilting the second member. [symbol] tis downward movement of the connecting element pulls on the strip member 118, [symbol] using the lid 120 to pivot and open the bin 110, as seen in FIG. 6B. Releasing the [symbol] dal 132, will reverse the action of the pedal mechanism 135 via the torsion bars, thus) [symbol] sing the lid 120 over the bin 110. Due to the flexibility and the elasticity of the [symbol] rsion bars and the hinges connecting the base lever member, the action can be [symbol] peated numerous times, without causing any structural damage.

It should be appreciated that the lid 120 can be opened by directly pivoting it [symbol] irection of arrow P), however in such a case the pedal mechanism 130 will not be [symbol] tuated.

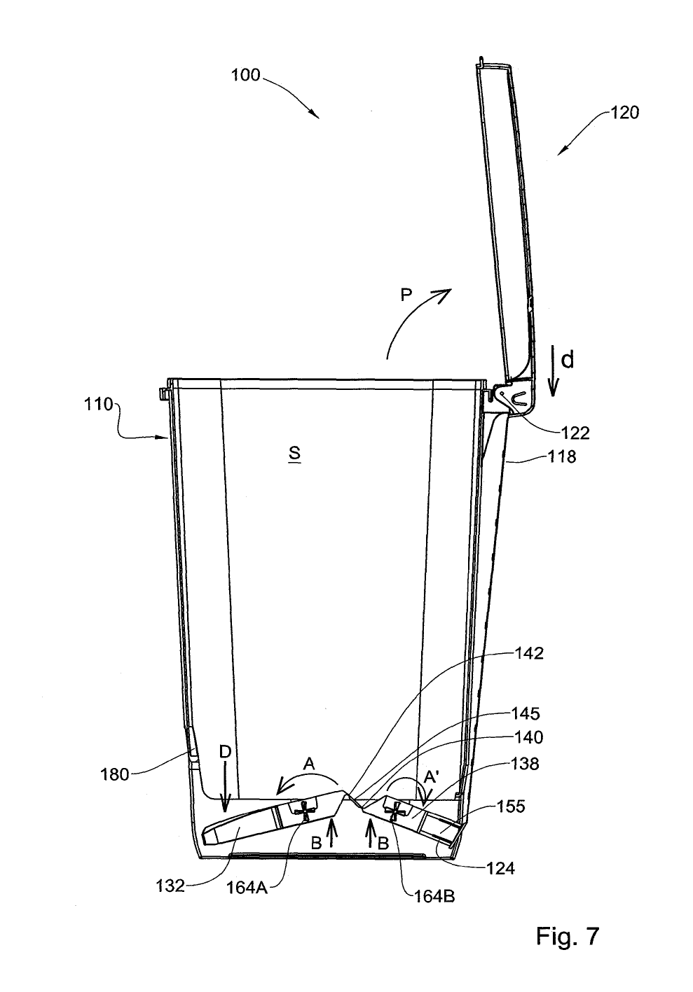

As described herein, in the illustrated example the pedal mechanism 130 and the [symbol] n 110 are molded as a unitary and integral structure. It will be appreciated however [symbol] at the pedal mechanism can be a separate part fixedly attached to the bin. As best seen [symbol] FIGS. 3 and 7, the pedal mechanism, in the illustrated example, including the pedal [symbol] ember 132 are designed so as not to protrude beyond the boundaries of the bin front [symbol] 3B and rear walls 111AB. As indicated above, the front wall is provided with an [symbol] ening 180 allowing access to the pedal 132. It will be appreciated that in accordance [symbol] ith another example, the pedal can extend outside the bin boundaries.

The structural features of the bin of the illustrated example allow for ease of) [symbol] lding and safe storage as well as nesting within a like bin. Furthermore, the sidewalls [symbol] the bin are slightly tapered thus allowing the nesting within a like bin with the lid [symbol] her in an open position or removed from the bin. This nesting provides, e.g. for a [symbol] mpact transportation. It will be appreciated that the shape of the bin can vary. It can [symbol] cylindrical, oval or any polyhedral shape.

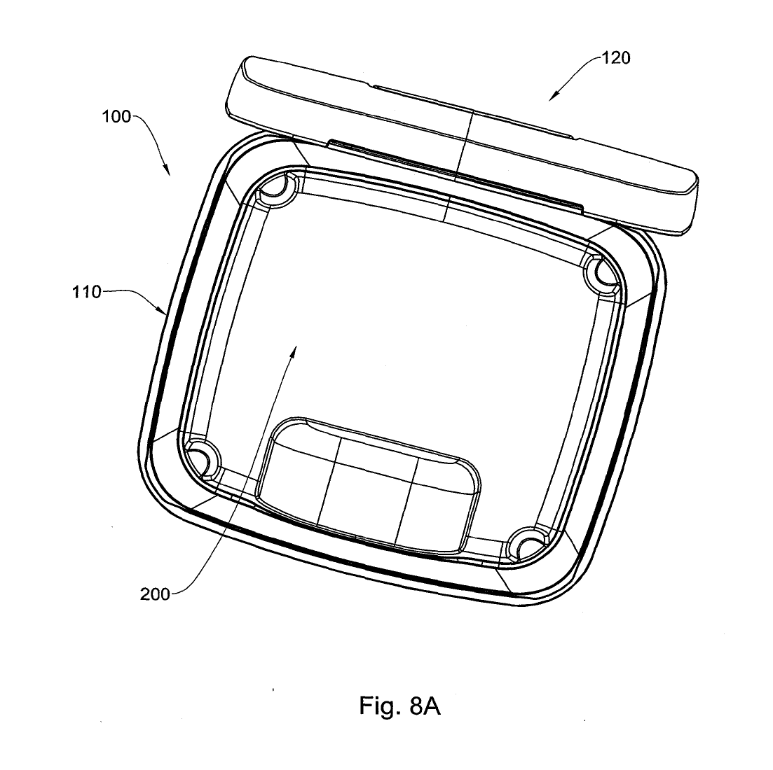

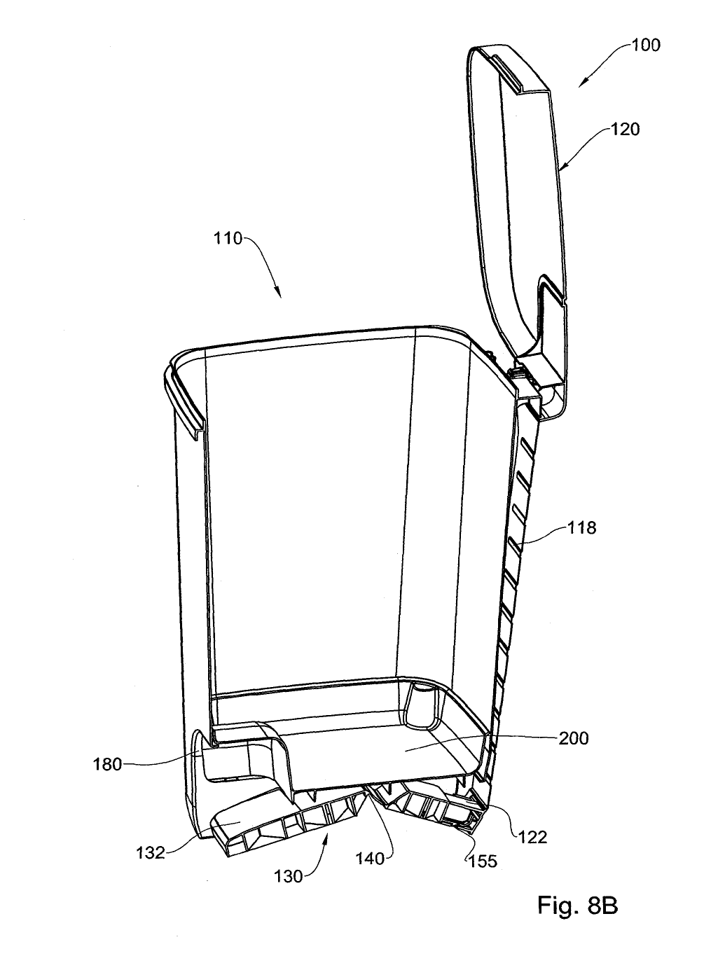

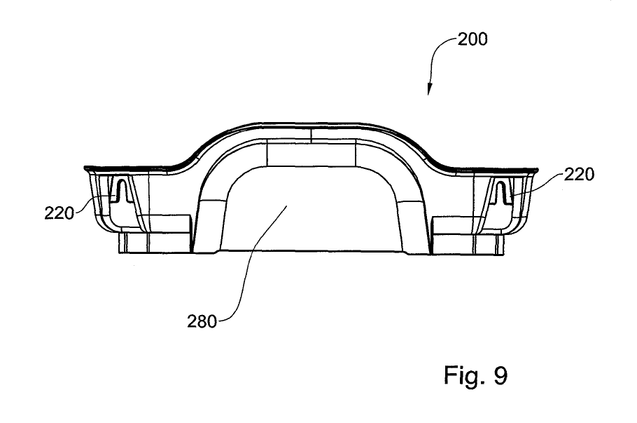

To protect the pedal mechanism and to prevent soiling thereof and of the surface [symbol] derneath thereof, the pedal type bin 100 assembly further comprises a bin liner 200, [symbol] in FIG. 8A. This liner 200 fits above the pedal mechanism 130, covering it [symbol] mpletely. The outer edges of the liner are provided with hook-like extensions 220, [symbol] nfigured for engaging corresponding protrusions over the supporting walls 160A and [symbol] 0B on the bin bottom 114. As seen further in FIG. 8B, the liner is provided with an [symbol] wardly extending concave wall portion 210 (also seen in FIG. 9) which closes the [symbol] ening 180 whilst also allowing sufficient space to guide the users' foot to the pedal [symbol] 2. The liner rests on the supporting walls 160A and 160B extending at the inner [symbol] rface of the bin bottom. The height of the supporting surfaces 160A and 160B is high [symbol] ough to prevent the bottom surface of the liner from unintentional contact with the [symbol] dal mechanism. It will be appreciated that the liner can constitute an inner bin, e.g. to [symbol] ver substantially the entire inner surface and the side walls of the bin. The liner and/or [symbol] e inner bin can be removable or fixedly attached to the bin.

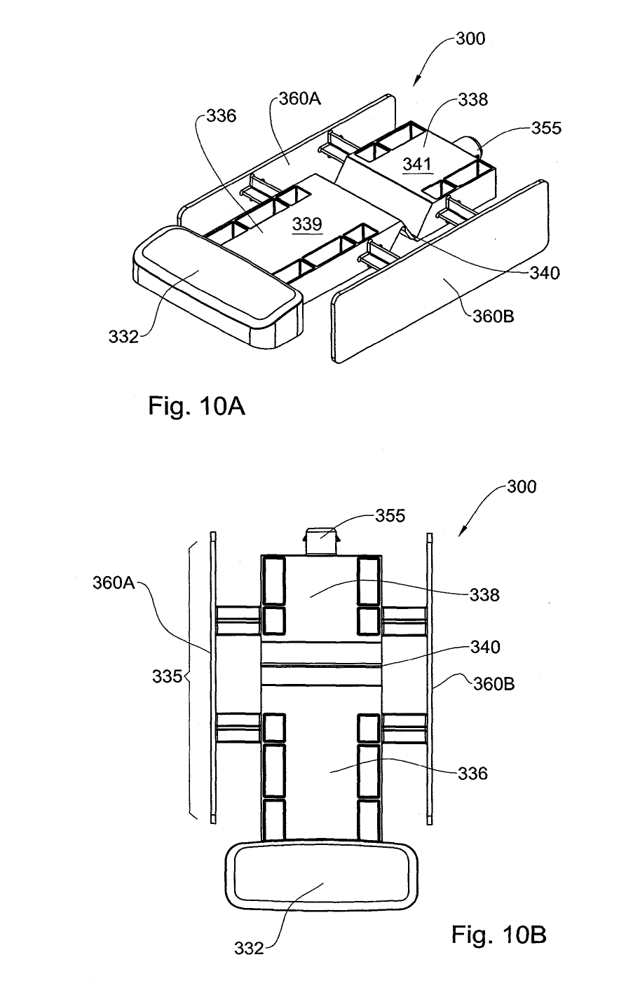

Turning now to FIGS. 10A and 10B, there is provided a pedal mechanism 300 in [symbol] accordance with an example of the disclosed subject matter. The pedal mechanism 300 [symbol] similar to the one described with reference to FIGS. 3 and 6B with the difference [symbol] siding in that this mechanism is independent of any structure. It will be appreciated [symbol] at such a mechanism can be used in conjunction with any type of structure having a [symbol] over or a portion of a cover manipulable between a closed and an open position. While [symbol] the previous example the torsion bars 162AB and 164AB were restrained by the [symbol] pporting surfaces extending from the side walls of the bin, as seen in the illustrated [symbol] ample, the laterally extending torsion bars configured to axially support the base lever [symbol] e connected to and restrained by two parallely extending supporting surfaces.

The pedal mechanism of FIGS. 10A and 10B will now be described, with [symbol] ements functionally corresponding to elements in the previous example upped by 300. [symbol] he pedal mechanism 300 comprises a base lever 335 actuated by a pedal 332 (which in this example forms an integral part of the pedal mechanism however it will be [symbol] preciated that this element can be detachably attachable or a separate member fixedly [symbol] ed thereto). The base lever 335 has a first, front member 336 and a second, rear [symbol] tuber 338 flexibly connected through a hinge 340, in this example an integral hinge. [symbol] will be appreciated that the first member and the second member can be separate [symbol] tubers interconnected through at least one hinge. The front member 336 has a fore [symbol] d connecting to the pedal 332 and a rear end 337 configured for connecting to the [symbol] ond member 338, a top surface 339 and a bottom surface (not shown); the second [symbol] tuber 338 has a fore end configured for connecting to the first member 336 and a rear [symbol] d fitted with a connecting element 355 which is an outward protrusion configured to [symbol] engage a manipulating member. Other types of connections are envisioned, e.g. a [symbol] ap type connection, adhesion, welding, hinged connection, etc. or integration of the [symbol] rts in one single unit. It will be appreciated that the mechanism can be devoid of this [symbol] nnecting member.

The second member 338 further has a top surface 341 and a bottom surface (not [symbol] own). The integral hinge 340 extends diagonally from the top surface of the first [symbol] ember 336 to the bottom surface of the second member 338. In the present example, [symbol] connection between the top rear end of the first member 336 to the hinge 340 at the [symbol] ttom fore end of the second lever member 338 extends through another integral hinge [symbol] 2. In the illustrated example, the first member and the second member are diagonally [symbol] nnected by an intermediate hinging strap 345, connecting the members through the [symbol] ages 340 and 342. Thickness of the hinging strap 345 is smaller than that of the lever [symbol] embers and larger than that of the hinges constituted by thinned out portions (e.g. [symbol] tegral hinges). However it will be appreciated that the connection can be made using [symbol] ernative connecting members, e. g., one or more connecting strings etc.

The base lever 335 is connected laterally to two supporting surfaces 360A and [symbol] 0B extending in parallel by torsion bars 362A, 362B, 364A and 364B configured to [symbol] ially support the base lever 335. This allows controlled swinging of the base lever 335 [symbol] nd if present of the pedal member 332) relative to the supporting surfaces when the [symbol] rce applied at a frond edge of the front member 336 is transmitted to the rear edge of [symbol] e rear member 338. The torsion bars connected to the supporting surfaces have thus a [symbol] strained warping at the root which allows the base lever members 336 and 338 to [symbol] ving back to their initial position when the force is released.

The torsion bars 362 have a shape of cross (+) in their cross section. However, it [symbol] be appreciated that bars having another cross section are envisioned, as exemplified [symbol] FIGS. 5A to 5C, showing a y-shaped, a straight line or an X-shaped bars, respectively, [symbol] well as I, U or other shapes of bars which can be used as torsion axis bars.

1. A pedal type bin assembly comprising a bin having a top and a bottom, a lid pivotably attached at a top portion of a rear wall of the bin, and a pedal mechanism disposed at a bottom portion of the bin, wherein the bin further comprises a lid manipulating member extending between the lid and the pedal mechanism and wherein the pedal mechanism comprises a pedal provided at a front portion at the bottom portion of the bin, a force transmitting system and a connecting element couplable to the lid manipulating member at a rear portion of the bin bottom portion, configured for manipulating the lid between an open and a closed position upon respective operation of the pedal mechanism, opening the lid by pulling on the lid manipulating member, wherein the pedal mechanism forms part of the bins base portion at the bottom thereof with the bin and the pedal mechanism, being a unitary structure.

2. The pedal type bin according to claim 1, further comprising a bin liner or an inner bin configured to at least partially line and cover an inside surface of the bin.

3. The pedal type bin according to claim 2, wherein the liner is configured to cover at least the bottom portion of the inside surface of the bin and wherein the liner can be an integral part of the bin or a removable component thereof.

4. The pedal type bin according to claim 1, wherein the pedal mechanism comprises a base lever actuatable by the pedal, the base lever having a first member and a second member flexibly connected through at least one hinge, wherein each of the front member and the second member comprise at least one laterally extending torsion bars configured to axially support the base lever and connecting it to laterally extending parallel supporting surfaces and wherein the torsion bars allow swinging of the base lever relative to the supporting surface and wherein the force applied at a frond edge of the front member is transmitted to the rear edge of the rear member.

5. The pedal type bin according to claim 1, wherein the bin and the pedal mechanism are a unitary and integral structure.

6. The pedal type bin according to claim 1, wherein the pedal mechanism and the bin are articulated to each other.

7. The pedal type bin in accordance with claim 1, wherein the pedal and the force transmission mechanism are integrally formed.

8. The pedal type bin according to claim [symbol] , wherein the pedal is detachably attachable to the pedal mechanism.

9. The pedal type bin according to claim 4, wherein the first member and the second member can be an integral unit interconnected by an integral hinge.

10. The pedal type bin according to claim 4, wherein the first member and the second member can be separate elements configured for articulation one with the other through at least one hinging member.

11. The pedal type bin according to claim 1, wherein at least the pedal mechanism and/or the pedal bin can be formed from plastic.

12. The pedal type bin according to claim 1, further comprising a multi-lever rocker actuating mechanism comprising a first lever member pivotable about a first axis and a second lever member pivotable about a second axis, a front end of the first lever comprising an actuating pedal and a rear end of the first lever is pivotally articulated to a front end of the rear lever; a rear end of the rear lever is configured for articulating to a bottom end of a lid manipulating member having a top end thereof pivotally articulated to a pivot at the rear end of the lid, wherein downward displacement of the actuating pedal entails pivoting of the first lever in a first direction and corresponding pivotal displacement of the second lever in an opposite direction, such that the rear end of the second lever displaces downwards, resulting in corresponding downwards displacement of the lid manipulating member, whereby downwards displacement of the lid manipulating member in turn entails downwards displacement of the rear lid portion, resulting in pivotal displacement of the lid into its open position.

13. The pedal type bin according to claim 12, wherein the following parameters alter the force and displacement factors of the lid actuating mechanism which comprises the pedal mechanism disposed at a bottom portion of the bin and a lid manipulating member the length of the levers, or/and the positioning of the axes of the levers, and/or pre-angular positioning of the levers.

14. The pedal type bin according to claim 12, wherein the first axis and the second axis are substantially parallel to one another.

15. The pedal type bin according to claim 12, wherein the at least first lever and the at least second lever are connected directly to each other.

16. The pedal type bin according to claim 12, wherein the at least first lever and the at least second lever are connected through an interconnecting link and wherein the interconnecting link extends between the top rear of the first lever member and bottom front of the second lever member.

17. The pedal type bin according to claim 12, wherein an axis extending through the first lever and the second lever are constituted by torsion bars.

18. A multi-lever rocker actuating mechanism comprising a first lever member pivotable about a first axis and a second lever member pivotable about a second axis, a front end of the first lever comprising an actuating pedal and a rear end of the first lever is pivotally articulated to a front end of the rear lever; a rear end of the rear lever is configured for articulating to a bottom end of lid manipulating member having a top end thereof pivotally articulated to a pivot at the rear end of the lid, wherein downward displacement of the actuating pedal entails pivoting of the first lever in a first direction and corresponding pivotal displacement of the second lever in an opposite direction, such that the rear end of the second lever displaces downwards, resulting in corresponding downwards displacement of the lid manipulating member, whereby downwards displacement of the lid manipulating member in turn entails downwards displacement of the rear lid portion, resulting in pivotal displacement of the lid into its open position.

19. A pedal mechanism, comprising:
a base lever actuatable by the pedal, the base lever having a first member and a second member flexibly connected through at least one hinge, each of the front member and the second member comprise at least one laterally extending torsion bars configured to axially support the base lever and connecting it to laterally extending parallel supporting surfaces,
wherein the torsion bars allow swinging of the base lever relative to the supporting surface and wherein the force applied at a frond edge of the front member is transmitted to the rear edge of the rear member.
